(19) United States
(12) Patent Application Publication
(10) Pub. No.: US 2012/0326081 A1
(43) Pub. Date: Dec. 27, 2012

(54) CARBON BRUSH

(75) Inventors: Yoshikazu Kagawa, Kanonji-shi (JP); Takashi Maeda, Kanonji-shi (JP); Takuji Fujimura, Kanonji-shi (JP); Hidenori Shirakawa, Kanonji-shi (JP)

(73) Assignee: TOYO TANSO CO., LTD., Osaka-shi, Osaka (JP)

(21) Appl. No.: 13/582,873

(22) PCT Filed: Mar. 25, 2011
(86) PCT No.: PCT/JP2011/057308

§ 371 Date: Sep. 5, 2012

(30) Foreign Application Priority Data
Mar. 26, 2010 (JP) 2010-071820

(51) Int. Cl. C09K 3/00

(52) U.S. Cl. 252/182.32

(57) ABSTRACT

A carbon brush is provided that improves motor efficiency and achieves a longer service life. A carbon brush (1) to be pressed against an electrically-conductive rotor (2) is characterized by containing mesocarbon powder and an aggregate material containing carbon as at least one component thereof. It is preferable that the mesocarbon powder have a substantially spherical shape, and it is also preferable that the mesocarbon powder has been subjected to a preheating treatment. In addition, it is preferable that the temperature of the preheating treatment be from 500° C. to 700° C.

### TECHNICAL FIELD

The present invention relates to a carbon brush for electric motors using a commutator, for use in home electrical appliances, power tools, and automobiles, and particularly to a carbon brush incorporated in a small-sized motor using a commutator.

### BACKGROUND ART

Electric motors have increasingly become smaller in size, larger in capacity, and higher in output power. For example, motors used for vacuum cleaners are required to be even smaller and achieve higher suction power. For this reason, the outer diameter of the fan of the motors is made smaller so that it can be rotated at an ultra-high speed (30000 rpm or higher). In such a motor with ultra-high speed rotation, it is necessary to maintain proper electrical contact by keeping a good rubbing condition between a carbon brush for electric machine and a commutator, which is an electrically-conductive rotor, so that the motor efficiency can be improved. Moreover, it is necessary to make the service life longer so that the brush does not need to be replaced during the service life of the vacuum cleaner.

In view of these points, it has been proposed to use a resin bond-based carbon brush made of a material in which graphite powder is bonded by a resin binder. With the carbon brush having such a configuration, the service life of the carbon brush cannot be prolonged although the motor efficiency may be improved to some degree. The reason is as follows. Because of the rubbing action for a long period of time, a thick carbon film is formed on the surface of the commutator. Thereafter, if the film peels off partially, a large current passes through the peeled portion, causing sparks. Consequently, surface uneveness forms on the surface of the carbon brush.

In view of the problem, there has been a proposal that an abrasive material such as SiC (silicon carbide) powder is added to the carbon brush (see Patent Document 1). With such a proposal, when a carbon film is formed on the surface of the commutator by rubbing the carbon brush against the commutator, the film can be scraped off by the SiC, so that the film can be inhibited from becoming thicker. As a result, the service life of the carbon brush can be prolonged. However, the SiC powder also scrapes off the surface of the commutator little by little because of the rubbing action, so the motor efficiency degrades.

### CITATION LIST

### Patent Literature

[Patent Document 1]

JP 2000-197315 A

### SUMMARY OF INVENTION

### Technical Problem

As described above, if an abrasive material such as SiC (silicon carbide) powder is not added to the carbon brush, the service life of the carbon brush becomes short although the motor efficiency increases. On the other hand, if SiC is added to the carbon brush, the motor efficiency degrades although the service life of the carbon brush can be prolonged. For these reasons, it has been difficult in the past to achieve both an improvement in the motor efficiency and a longer service life of the carbon brush.

Accordingly, it is an object of the present invention to provide a carbon brush that can improve the motor efficiency and achieve a longer service life.

### Solution to Problem

In order to accomplish the foregoing object, the present invention provides a carbon brush to be pressed against an electrically-conductive rotor, characterized by containing mesocarbon powder and an aggregate material containing carbon as at least one component thereof.

The mesocarbon powder shows low grinding capability than SiC powder and therefore can inhibit the commutator from being scraped off. Therefore, the rubbing characteristic between the commutator and the carbon brush are improved, and the motor efficiency can be improved. Moreover, although the mesocarbon powder shows lower grinding performance than SiC powder, it can scrape off (clean) the carbon film formed on the surface of the commutator. As a result, a longer service life of the carbon brush can be achieved. Moreover, the carbon film formed on the surface of the commutator can be inhibited from being peeled off partially. Therefore, it is possible to prevent large current from passing through the peeled portion and to inhibit the EMI performance from degrading.

It is desirable that the mesocarbon powder have a substantially spherical shape.

When the mesocarbon powder has a substantially spherical shape (the shape as shown in FIGS. 3 and 4), the rubbing surface between the mesocarbon powder and the commutator is larger than when the mesocarbon powder is in an indefinite shape (the shape shown in FIG. 2, and a shape not regarded as a substantially spherical shape as shown in FIGS. 3 and 4), so the grinding ability to the carbon film is improved further. Moreover, since the rubbing surface with the commutator becomes larger, the concentration of the external force applied to the commutator can be inhibited. As a result, the commutator surface is unlikely to be damaged. Furthermore, when the mesocarbon powder is in an indefinite shape, the shape and particle size are greatly different between the particles; on the other hand, when the mesocarbon powder is in a substantially spherical shape, the shape and particle size become almost uniform between the particles. As a result, stable grinding ability can be obtained.

It should be noted that the term “substantially spherical shape” means to include ones having an elliptical cross section, and ones having an indefinite shape without an angular corner so that the shape as a whole is close to the spherical shape, in addition to ones having a spherical shape.

It is desirable that the mesocarbon powder be one having been subjected to a preheating treatment, in which the mesocarbon powder is heated in advance of adding it to a brush material, such as graphite powder.

When using the mesocarbon powder having been subjected to a preheating treatment, the grinding effect to the carbon film can be enhanced further. Moreover, even when the mesocarbon powder is subjected to the preheating treatment, almost no change occurs in the shape of the mesocarbon. Therefore, the same advantageous effects as described above can be obtained when using the mesocarbon powder having a substantially spherical shape.

It is desirable that the temperature of the preheating treatment be from 500° C. to 700° C.

When the preheating treatment is carried out outside the just-mentioned temperature range, the motor efficiency may not be improved sufficiently. Although the reason is not clear, it is considered that the mesocarbon powder may become too hard when the temperature exceed 700° C., and consequently, the wearing of the commutator becomes great, reducing the motor efficiency.

It is desirable that the carbon brush further contain a binder in addition to the aggregate material and the mesocarbon powder, and that the amount of the mesocarbon powder be from 0.1 mass % to 10.0 mass % with respect to the total amount of the binder and the aggregate material.

If the amount of the mesocarbon powder is less than 0.1 mass %, the hardness of the carbon brush lowers, and the brush abrasion loss becomes greater (i.e., the advantageous effects of adding the mesocarbon powder cannot be obtained sufficiently). On the other hand, if the amount of the mesocarbon powder exceeds 10.0 mass %, the carbon film formed on the commutator surface is scraped off too much, and good rubbing performance cannot be obtained. This increases the contact resistance, and a greater voltage drop occurs. As a consequence, the life of the carbon brush is shortened, and also, the motor efficiency is reduced because of the increased friction.

It is desirable that the mesocarbon powder have an average particle size of from 5 μm to 80 μm (preferably from 10 μm to 40 μm, more preferably from 20 μm to 30 μm).

If the average particle size of the mesocarbon powder exceeds 80 μm, the friction force between the particles becomes greater, degrading the slipping between the particles. Consequently, the rubbing performance between the commutator and the carbon brush becomes poor. This increases the contact resistance, and a greater voltage drop occurs. As a consequence, the same problem as described above arises. On the other hand, if the average particle size of the mesocarbon powder is less than 5 μm, the friction force between the particles becomes smaller, so the slipping between the particles becomes better. However, the grinding effect to the film formed on the commutator surface is lessened. As a consequence, good rubbing performance between the commutator and the brush cannot be maintained, and the abrasion loss of the carbon brush is increased.

A carbon brush, characterized by having a motor efficiency of greater than 42% and a brush life of longer than 800 hours, as determined in a motor efficiency measurement in which the brush is pressed against a motor when the motor has been continuously operated for 700 hours under the following measurement conditions: a brush spring pressure to the motor of 41 KPa; a voltage of AC 240 V, 50 Hz; and a motor revolution of 32000 rpm. Thereby, the motor efficiency can be improved, and moreover, the service life of the carbon brush can be prolonged.

It should be noted that, in the present specification, the particle size and the average particle size of the mesocarbon powder were determined from the particle size distribution (based on volume) obtained with a particle size analyzer using a laser diffraction/scattering method. The measurement device used was a Microtrac particle size analyzer 9320HRA, made by Nikkiso Co., Ltd. The average particle size was obtained at the median particle diameter (50% diameter). The particle size and the average particle size of graphite powder were also obtained in the same manner.

### Advantageous Effects of Invention

The present invention achieves significant advantageous effects of achieving a longer service life of the carbon brush while inhibiting motor efficiency from degrading, and moreover improving EMI performance.

### BRIEF DESCRIPTION OF DRAWINGS

FIG. 1 is a perspective view illustrating the schematic configuration of a motor using a brush according to the present invention.

FIG. 2 is a SEM photograph of mesocarbon powder used for the present invention brush A1.

FIG. 3 is a SEM photograph of mesocarbon powder used for the present invention brush A2.

FIG. 4 is a SEM photograph of mesocarbon powder used for the present invention brush A3.

FIG. 5 is a polarizing microscope photograph of a carbon brush using mesocarbon powder that has not undergone a heat treatment.

FIG. 6 is a polarizing microscope photograph of a carbon brush using mesocarbon powder that has undergone a heat treatment at 600° C.

FIG. 7 is a graph showing motor efficiency of the present invention brushes A1 to A3 and the comparative brushes Z1 and Z2.

FIG. 8 is a graph showing brush life of the present invention brushes A1 to A3 and the comparative brushes Z1 and Z2.

FIG. 9 is a graph showing commutator abrasion rate of the present invention brushes A1 to A3 and the comparative brushes Z1 and Z2.

FIG. 10 is a graph showing the relationship between frequency and terminal disturbance voltage for the present invention brush B and the comparative brush Y.

FIG. 11 is a graph showing the relationship between frequency and disturbance power for the present invention brush B and the comparative brush Y.

FIG. 12 is a graph showing motor efficiency of the present invention brushes A3, C1, and C2, and the comparative brushes Z1 and Z2.

FIG. 13 is a graph showing motor efficiency of the present invention brushes A3, D1, and D2, and the comparative brushes Z1 and Z2.

### DESCRIPTION OF EMBODIMENTS

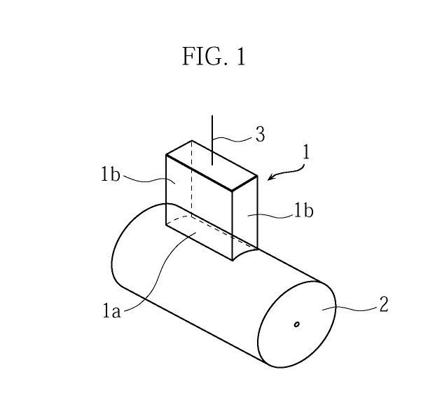

Hereinbelow, embodiments of the present invention will be described with reference to the drawings. FIG. 1 shows the schematic configuration of a motor using a brush according to the present invention.

As illustrated in FIG. 1, a brush 1 has such a structure that a lower surface 1a of the brush 1 makes contact with a rotor 2, which is the commutator of the motor, so that a sliding action is performed at that portion. A lead wire 3 is attached to the brush 1.

Examples of the manufacturing method of the brush 1 include the following:

(A) One produced by kneading graphite powder (powder of natural graphite or electrographite) and mesocarbon powder to bond them to each other with the use of a binder such as a thermosetting synthetic resin, and performing a heat treatment at the thermosetting temperature of the resin to harden the resin. (Resin bonded brush)

(B) One that uses a raw material prepared by using a mixture made by kneading graphite powder (powder of natural graphite or electrographite), a binder such as microcrystalline carbon (amorphous carbon) or resin or pitch, and mesocarbon powder as the main material. For example, one prepared by sintering the just-described mixture at a low temperature of from 400° C. to 800° C. to carbonize the binder or the microcrystalline carbon. (Carbon graphite brush)

(B) is also called a graphite carbon brush, depending on the proportion of the graphite powder.

Other examples include electrographite brush, artificial graphite brush, carbonaceous brush, natural graphite brush, and metal graphite brush. In the present invention, it is possible to use any of the raw materials. For the brush of the present invention, it is particularly preferable to use the resin bonded brush or the carbon graphite brush as a base material.

A specific example of the manufacturing method of the brush 1 may be as follows. Graphite powder, a binder, and mesocarbon powder are kneaded together, and the kneaded mass is pulverized to prepare powder for shaping. Thereafter, the resultant powder is shaped into a brush base material shape, followed by a heat treatment.

Here, the details of the mesocarbon powder, the graphite powder, and the binder will be described in the following.

(1) Mesocarbon Powder

Mesocarbon powder refers to a substance obtained as follows. Pitches (including heavy petroleum) are heat-treated, and the heat-treated pitches are separated with an organic solvent, an solvent, or the like, and infusibilized. Examples of the pitches include a coal-tar pitch, which is a distillation residue of coal tar that is produced as a by-product during dry distillation of coal, a pitch of a thermal decomposition residue of asphalt, which is a distillation residue of petroleum, and a pitch originating from the tar that is produced as a by-product when thermally decomposing or fluid catalytic cracking naphtha. Alternatively, the heat-treated pitches may be grown in a solidification chamber, thereafter pulverized, and infusibilized. Further, the substances obtained in the just-described manners may be calcinated at a calcination temperature of from 200° C. to 450° C., or may be sintered at a sintering temperature of 400° C. or higher. In addition, the mesocarbon powder may be subjected to a particle size adjustment as needed.

Specific examples of the mesocarbon powder include mesophase carbon microbeads, ones obtained by calcinating the mesophase carbon microbeads, and ones obtained by sintering the mesophase carbon microbeads, as well as bulk mesophase, ones obtained by calcinating the bulk mesophase, and ones obtained by sintering the bulk mesophase.

The mesophase carbon microbeads are produced by, for example, heat-treating coal-tar pitch so that the aromatic components in the tar or the pitch undergo condensation or stacking. When the heat treatment for the coal-tar pitch is conducted further, the mesophase carbon microbeads within the coal-tar pitch coalesce with each other, producing a bulk mesophase. The just-mentioned heat treatment may be conducted under any of the reduced pressure, normal pressure, and increased pressure conditions. It is desirable that the heat treatment be conducted within the temperature range of from 350° C. to 500° C. (preferably from 380° C. to 480° C.) for 10 minutes or longer. It is also desirable that the heat treatment be conducted from one time to a plurality of times. The atmosphere in the heat treatment may be a non-oxidizing or a slightly oxidizing atmosphere. Thereafter, pulverization and infusibilization are performed, and a particle size adjustment may be performed as needed. The slightly oxidizing atmosphere means an atmosphere in which the oxygen concentration is about 5 volume % or less.

Alternatively, it is possible to use a mesocarbon powder prepared by separating the mesophase carbon microbeads in the coal-tar pitch obtained in the above-described method with the use of a solvent, classifying the separated material by filtration, and calcinating the classified material at a calcination temperature of about 200° C. or higher. Similarly, it is also possible to use a mesocarbon powder prepared by calcinating the bulk mesophase. Furthermore, it is also possible to use a mesocarbon powder prepared by separating the mesophase carbon microbeads in the coal-tar pitch obtained in the above-described method with the use of a solvent, classifying the separated material by filtration, and sintering the classified material at a sintering temperature of from about 500° C. to about 1300° C. Similarly, it is also possible to a mesocarbon powder prepared by separating the bulk mesophase with the use of a solvent, classifying the separated material by filtration, and sintering the classified material.

It is preferable that the mesocarbon powder obtained in the above-described manners undergo a preheating treatment before being added to graphite powder and a binder and kneaded together. For example, it is preferable that the preheating treatment be performed in a non-oxidizing atmosphere at a temperature of from 500° C. to 1200° C., more preferably from 500° C. to 700° C., and still more preferably from 550° C. to 650° C.

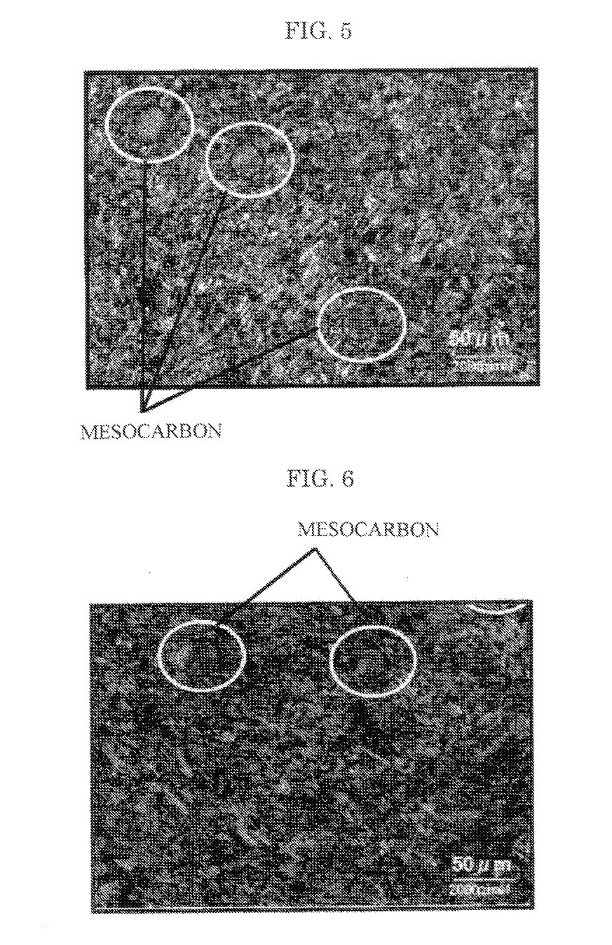

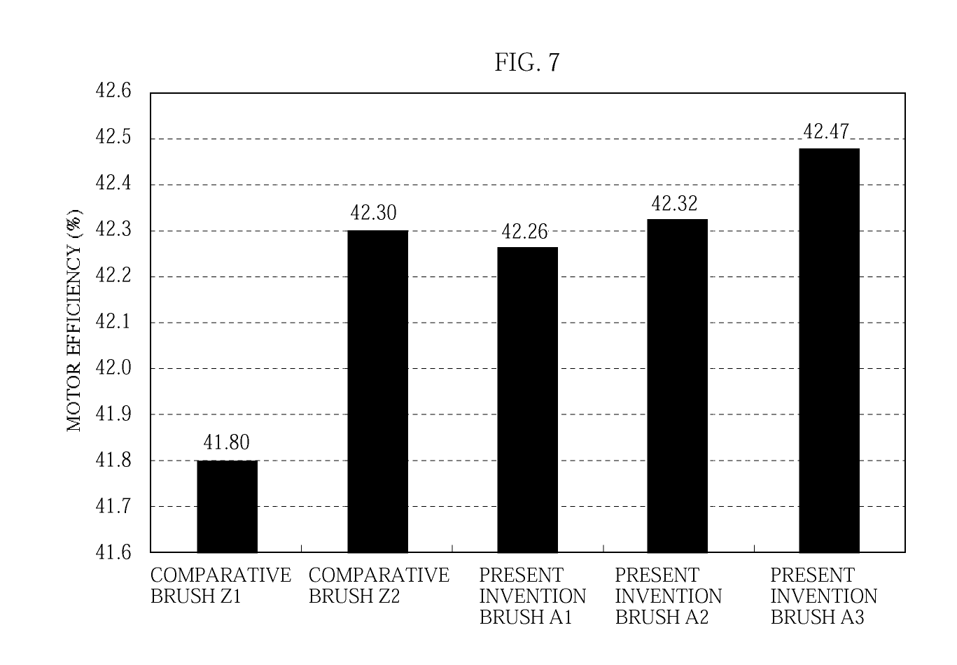

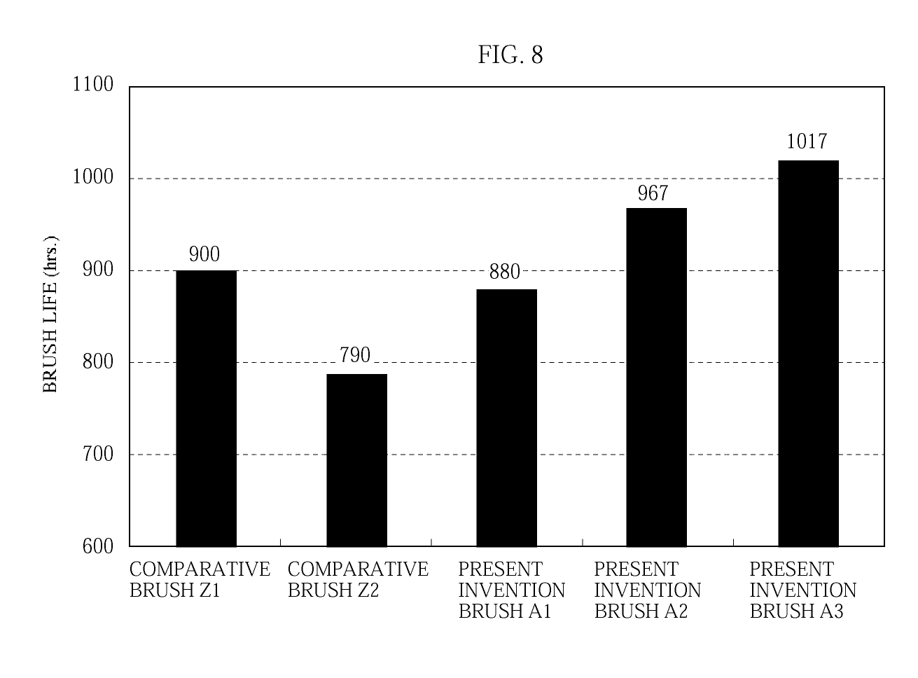

The mesocarbon powder in a carbon brush can be confirmed by observing an observation surface of the carbon brush with a polarizing microscope. The observation surface of the carbon brush may be prepared by embedding the carbon brush, which is the test sample, in an acrylic resin, an epoxy resin, a phenolic resin, or the like, then allowing the resin to harden, and thereafter, grinding the carbon brush together with the resin. The mesocarbon powder can be easily identified from the observation surface because it is kept in the shape when it was added to an aggregate material. When a sensitive color plate is inserted in the polarizing microscope and the carbon brush observation surface is observed, an interference color appears in the mesocarbon powder. For example, yellow is observed at a rotation angle of −45°, red at 0°, and blue at +45°. When the mesocarbon powder is observed with a crossed-Nicols of the polarizing microscope, the quenching line changes by rotating the sample from −45° to +45°. Here, FIG. 5 shows a polarizing microscope photograph of a carbon brush in which the mesocarbon powder obtained in the above-described manner was not subjected to a preheating treatment. FIG. 6 shows a polarizing microscope photograph of a carbon brush in which the mesocarbon powder was additionally subjected to a preheating treatment at 600° C. As is clear from FIGS. 5 and 6, the mesocarbon powder remains in a substantially spherical shape in the carbon brush regardless of whether the mesocarbon powder is subjected to a preheating treatment before it is added to graphite powder and a binder or the mesocarbon powder is used without being subjected to the preheating treatment.

In addition, the mesocarbon powder may be subjected to a particle size adjustment as needed. Here, the particle size adjustment can be performed by adjusting the heat treatment temperature or the calcination temperature, or by adjusting the heating time or the calcination time. For example, in the case that the particle size distribution becomes greater by increasing the heat treatment temperature or the calcination temperature or by increasing the heating time or the calcination time, the particle size distribution can be adjusted by classifying. When the particle size becomes great, the particle size distribution can be adjusted by, for example, pulverizing and classifying. By pulverizing the mesocarbon powder, the mesocarbon powder is allowed to have an indefinite shape. In addition, by pulverizing a material obtained by heat-treating coal-tar pitch and growing the treated material in a solidification chamber, it is also possible to allow the mesocarbon powder to have an indefinite shape. It is preferable that in the present invention, the aspect ratio of the mesocarbon powder be from 1 to 3, more preferably from 1 to 2, still more preferably from 1 to 1.5.

(2) Graphite Powder

As the graphite powder, it is possible to use any of natural graphite, artificial graphite, electrographite, and expanded graphite, and it is also possible to use any mixtures of combinations thereof. However, it is preferable to use artificial graphite because it has a low impurity content.

It is desirable that the amount of the graphite powder be from 60 mass % to 90 mass % with respect to the total amount of the graphite powder and the binder. When the amount of the graphite powder exceeds 90 mass %, the amount of the binder becomes relatively small, and the brush tends to have insufficient strength. On the other hand, if the amount of the graphite powder is less than 60 mass %, it becomes difficult to obtain desired carbon brush characteristics.

Moreover, although the particle size of the graphite powder is not particularly limited, it is preferable that the graphite powder have about the same particle size as that of the mesocarbon powder (which has a particle size of from 5 μm to 80 μm and an average particle size of from 10 μm to 40 μm). Specifically, it is desirable that the graphite powder have a particle size of from 1 μm to 100 μm and an average particle size of from 5 μm to 50 μm.

The reason for such restriction is that if the particle size of the graphite powder exceeds 100 μm, particle detachment is likely to occur easily during the rubbing action, and because of the sparks caused at the location, the abrasion of the brush is exacerbated. On the other hand, if the particle size of the graphite powder is less than 1 μm, the strength of the brush base material is low, and at the same time the amount of the binder is too large, making it difficult to obtain desired carbon brush characteristics. In contrast, when the particle size of the graphite powder is from 1 μm to 100 μm, the proportion of the detached particles is so small, even if particle detachment or the like occurs during the rubbing action. As a result, partial wearing does not occur, the strength of the brush base material is sufficient, and a long service life can be achieved.

Taking the foregoing into consideration, it is particularly desirable that the particle size of the graphite powder be from 10 μm to 80 μm and that the average particle size be restricted to from 10 μm to 30 μm.

(3) Binder

In addition to pitches and thermosetting resins, it is possible to use, as the binder, epoxy resins and phenolic resins in solid form or in liquid form and various types of thermosetting resins obtained by modifying them, for example. It is also possible to use combinations thereof

In addition, it is desirable that the amount of the binder be from 10 mass % to less than 40 mass % with respect to the total amount of the graphite powder and the binder. If the amount of the binder is less than 10 mass %, the bonding strength with the graphite powder or the like may be too low, and the brush strength may be insufficient. On the other hand, if the amount of the binder exceeds 40 mass %, it becomes difficult to obtain desired carbon brush characteristics because the blending amount of the graphite powder is too low.

It is also possible to add an addition agent such as molybdenum disulfide within such a range that the brush characteristics are not changed greatly (the amount of the addition agent is from 0.5 mass % to 5 mass % with respect to the total amount of the graphite powder and the binder). The reason for employing such an amount is as follows. If the amount of the addition agent is less than 0.5 mass %, the advantageous effects obtained by adding the addition agent cannot be obtained sufficiently. On the other hand, if the amount of the addition agent exceeds 5 mass %, the surface film formed on the commutator surface becomes too thick.

In addition, in the brush 1, a conductive metal film (for example, made of nickel, copper, or silver) may be formed on a portion of or the entirety of side faces 1b and an upper face 1a of the brush 1 excluding the lower surface la of the brush 1, at the stage of the brush base material. This film may be formed by a known method such as electroplating and electroless plating. The thickness thereof is generally, but not limited to, from 3 μm to 100 μm. Thereby, the resistance loss of the carbon brush is reduced in the rubbing action with the electrically-conductive rotor, and the rectifying performance is improved.

### EXAMPLES

### First Group of Examples

### Example 1

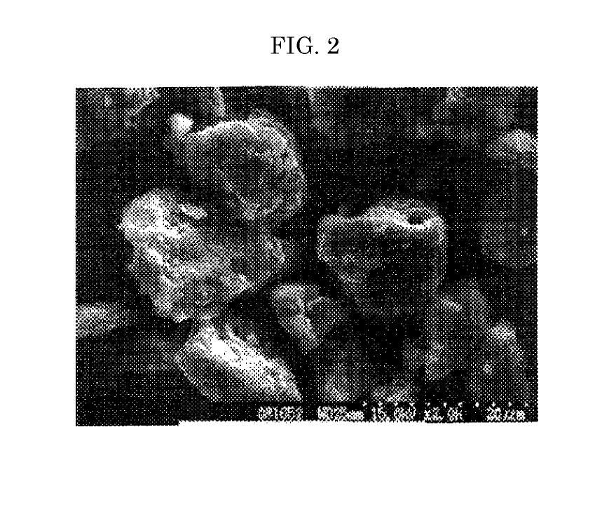

First, 77 mass % of artificial graphite powder (average particle size 20 μm) as an aggregate material and 23 mass % of epoxy resin (thermosetting resin) as a binder were blended, and thereafter, mesocarbon powder having an indefinite shape and not subjected to a preheating treatment (average particle size 20 μm, see FIG. 2) was added thereto. The mesocarbon powder was obtained by heat-treating coal-tar pitch, solidifying the treated material, pulverizing the solidified material, infusibilizing the resultant material, and subjecting it to a particle size adjustment. At this time, the amount of the mesocarbon powder was set at 1 mass % with respect to the total amount of the artificial graphite powder and the epoxy resin. Next, the artificial graphite powder, the resin, and the mesocarbon powder were kneaded at room temperature for a predetermined time (60 minutes) so that they can be uniformly mixed.

Subsequently, the kneaded material was pulverized to an average particle size 80 μm or less, to form a forming powder for forming a brush. This forming powder was formed at a pressure of 1 ton/cm² by cold pressing, and thereafter heat-treated at 180° C. under an inert atmosphere, whereby a carbon brush was fabricated.

The carbon brush fabricated in this manner is hereinafter referred to as a present invention brush A1.

### Example 2

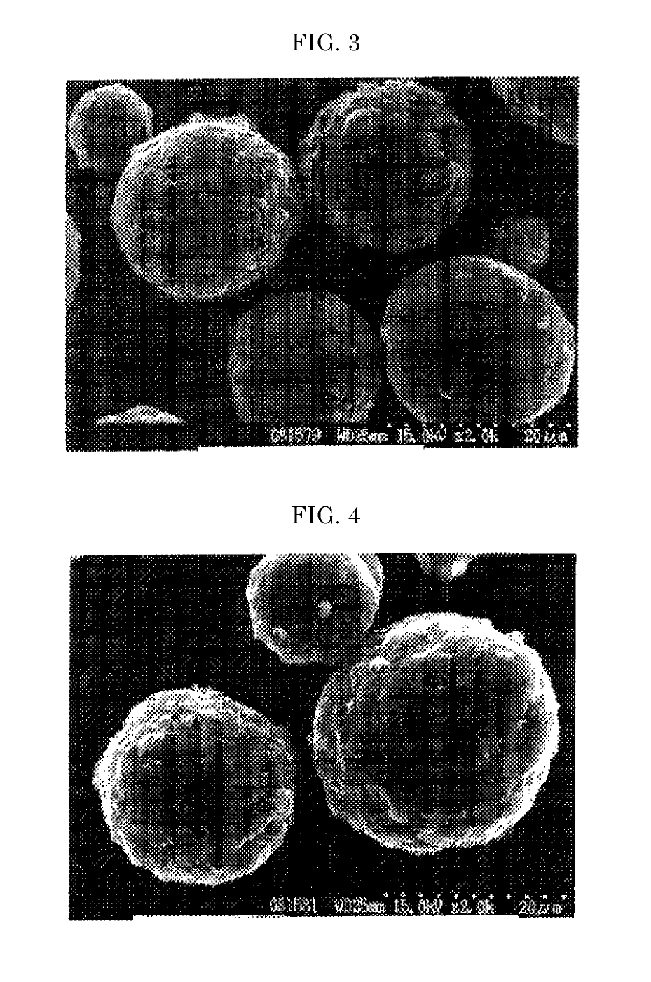

A carbon brush was fabricated in the same manner as described in Example 1 above, except that mesocarbon powder having a substantially spherical shape (average particle size 25 μm, see FIG. 3) that had not been subjected to a preheating treatment was used in place of the mesocarbon powder having an indefinite shape.

The carbon brush fabricated in this manner is hereinafter referred to as a present invention brush A2.

### Example 3

A carbon brush was fabricated in the same manner as described in Example 1 above, except that the mesocarbon powder having a substantially spherical shape used in Example 2 above was subjected to a preheating treatment at 600° C. for 5 hours, and the resultant mesocarbon powder (average particle size 26 μtm, see FIG. 4) was used in place of the mesocarbon powder having an indefinite shape.

The carbon brush fabricated in this manner is hereinafter referred to as a present invention brush A3.

### Comparative Example 1

A carbon brush was fabricated in the same manner as described in Example 1 above, except that SiC powder was added (the amount of which was 0.3 mass % with respect to the total amount of the artificial graphite powder and the epoxy resin) in place of the mesocarbon powder having an indefinite shape.

The carbon brush fabricated in this manner is hereinafter referred to as a comparative brush Z1.

### Comparative Example 2

A carbon brush was fabricated in the same manner as described in Example 1 above, except that the mesocarbon powder having an indefinite shape was not added.

The carbon brush fabricated in this manner is hereinafter referred to as a comparative brush Z2.

### Experiment 1

The motor efficiency for each of the present invention brushes A1 to A3 as well as the comparative brushes Z1 and Z2 was determined by the following measurement method. The results are shown in FIG. 7. The experiment was conducted under a humidity of from 30-40% and at room temperature (20-30° C.).

The measurement for the motor efficiency was conducted as follows. First, a lead wire was attached to each of the brushes, and each brush was fitted to a test motor with a spring pressure of 41 KPa. Thereafter, an AC voltage of 240 V with 50 Hz was applied to the motor, and the motor was continuously operated at a motor revolution of 32000 rpm. At this time, suction power P(W) for each brush was determined, and the motor efficiency was calculated from the following equation (1). (Note that the spring pressure used here was one according to JIS B 2704: 2009.)

η=(P/I)×100 (1)

In Equation (1), η is motor efficiency (%), P is suction power (W), and I is input power (W).

As is clear from FIG. 7, it is observed that the present invention brushes A1 to A3, each containing the mesocarbon powder, showed motor efficiencies of from 42.26% to 42.47%. This means that the resulting motor efficiencies were almost the same as or higher than that of the comparative brush Z2 containing no mesocarbon powder (the motor efficiency of which was 42.30%) and achieved improvements of more than 0.4% over the comparative brush Z1 containing SiC powder (the motor efficiency of which was 41.80%). In particular, the present invention brush A3, using the mesocarbon powder having been subjected to the heat treatment in advance, showed a motor efficiency of 42.47%, which was a remarkable improvement.

It should be noted here that an improvement in motor efficiency of 0.1% to 0.2% is a remarkable effect in the field of small-sized motors, and an improvement of about more than 0.4% over the comparative brush Z1 containing SiC powder, as obtained by the present invention brushes A1 to A3, is believed to be a tremendous effect. A brush with low power loss and high motor efficiency like the brush of the present invention is extremely suitable in the case where there is a restriction such that the input power cannot be made high because of the motor specification, for example.

### Experiment 2

The brush life was determined for each of the present invention brushes A1 to A3 as well as the comparative brushes Z1 and Z2. The results are shown in FIG. 8. The experiment was conducted as follows. The motor was operated for 700 hours under the same conditions as described in Experiment 1 above, and thereafter, the brush abrasion loss was measured. Then, the brush life was calculated from the following equation (2). In the following equation (2), the effective abrasion length was set at 30 mm.

Brush life (h)=Effective abrasion length 30 (mm)÷Brush abrasion loss (mm)×Motor operating time (h) (2)

As is clear from FIG. 8, it is observed that the present invention brushes A1 to A3, each containing mesocarbon powder, showed brush lives of from 880 hours to 1017 hours. This means that the resulting brush lives were substantially the same as or longer than that of the comparative brush Z1 containing SiC powder (the brush life of which was 900 hours) and were improvements over the comparative brush Z2 containing no mesocarbon powder (the brush life of which was 790 hours). In particular, the present invention brush A3, using the mesocarbon powder having been subjected to the pre-heating treatment, showed a brush life of 1017 hours, which was a remarkable improvement.

Thus, the carbon brush of the present application is a carbon brush that can improve the motor efficiency and prolong the brush life, the carbon brush having a motor efficiency of greater than 42% and a brush life of longer than 800 hours, as determined in a motor efficiency measurement in which the brush is pressed against a motor, wherein the motor is continuously operated for 700 hours under the conditions: a brush spring pressure to the motor of 41 KPa, a voltage of AC 240V, 50 Hz; and a motor revolution of 32000 rpm.

### Experiment 3

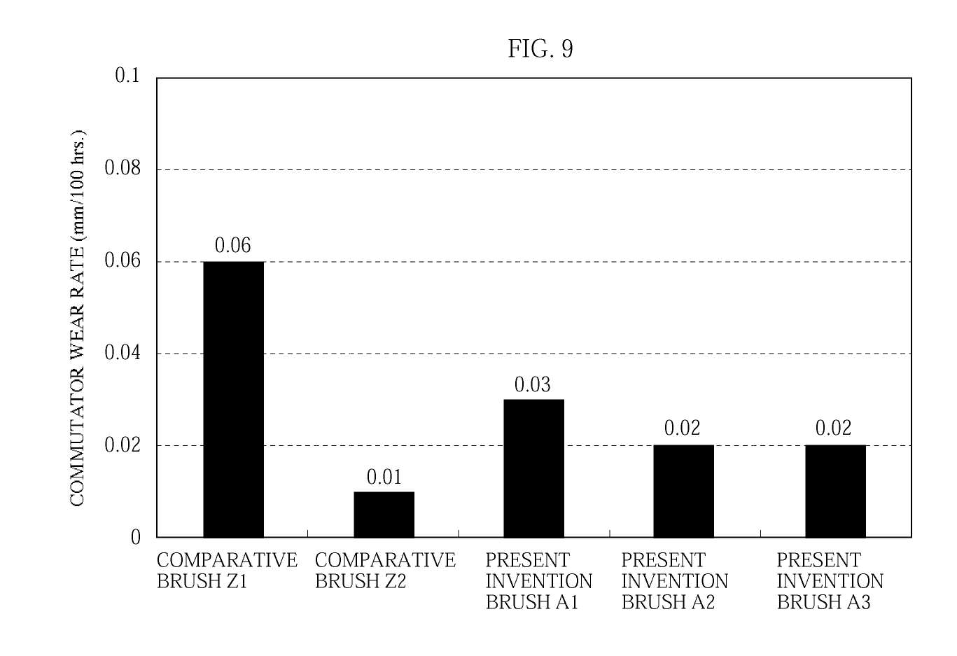

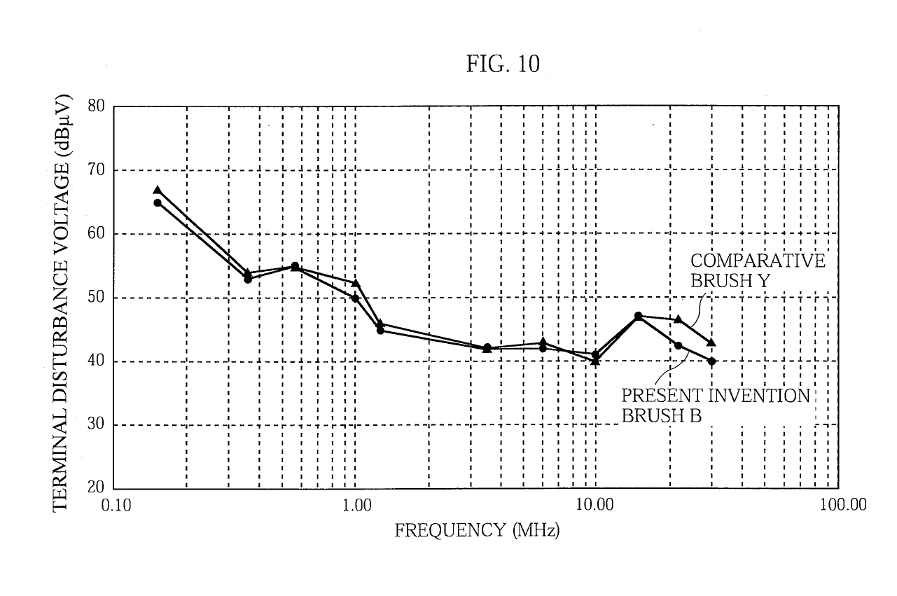

The commutator abrasion rate of each of motors using the present invention brushes A1 to A3 as well as the comparative brushes Z1 and Z2 was determined. The results are shown in FIG. 9. The experiment was conducted as follows. The motor was operated for 700 hours under the same conditions as described in Experiment 1 above, and thereafter, the commutator abrasion loss was measured. Then, the commutator abrasion rate was calculated from the following equation (3).

Commutator abrasion rate (mm/100 hrs.)=Commutator abrasion loss (mm)×100÷Motor operating time (h) (3)

As is clear from FIG. 9, it is observed that the present invention brushes A1 to A3 containing the mesocarbon powder showed commutator abrasion rates of from 0.02 mm/100 hrs. to 0.03 mm/100 hrs. This means that the resulting commutator abrasion rates were substantially the same as that of the comparative brush Z2 containing no mesocarbon powder (the commutator abrasion rate of which was 0.01 mm/100 hrs.) and were improvements over the comparative brush Z1 containing SiC powder (the commutator abrasion rate of which is 0.06 mm/100 hrs.). Thus, the commutator abrasion loss can be reduced, and a stable rubbing action can be obtained. As a result, sparks can be inhibited from occurring, and thereby a noise protection effect can be obtained.

### Experiment 4

The bulk density, hardness, resistivity, and flexural strength were determined for each of the present invention brushes A1 to A3 as well as he comparative brushes Z1 and Z2. The results are shown in Table 1.

TABLE 1

| | Additive | | | | | | | |
|---|---|---|---|---|---|---|---|---|
| | | | | Heat | | | | Flexural |
| | | | Amount | treatment | Bulk density | Hardness | Resistivity | strength |
| Brush | Type | Shape | (mass %) | (° C.) | (Mg/m³) | (Shore type C) | (μΩ · m) | (MPa) |
| A1 | Mesocarbon | Indefinite | 1 | No | 1.40 | 15 | 1011 | 18 |
| A2 | | Substantially | | | 1.40 | 15 | 979 | 18 |
| A3 | | spherical | | Yes | 1.39 | 15 | 1011 | 18 |
| | | | | (600) | | | | |
| Z1 | SiC | — | 0.3 | — | 1.40 | 15 | 900 | 18 |
| Z2 | None | — | — | — | 1.40 | 15 | 913 | 18 |

Table 1 above clearly shows that there is no significant difference in bulk density, hardness, resistivity, and flexural strength between the present invention brushes A1 to A3 and the comparative brushes Z1 and Z2.

### Experiment 5

The volatile component content and the ash content were determined for each of the mesocarbon powders used for the present invention brushes A1 to A3. The results are shown in Table 2. Table 2 also shows the average particle size of each of the mesocarbon powders. The ash content was determined according to JIS R7273-1997.

TABLE 2

| | Mesocarbon powder | | |
|---|---|---|---|
| | Volatile component content | Ash content | Average particle size |
| Brush | (mass %) | (mass %) | (μm) |
| A1 | 10.6 | 0.11 | 20 |
| A2 | 6.4 | 0.13 | 25 |
| A3 | 2.9 | 0.11 | 26 |

As is clear from Table 2, it is observed that although there is no significant difference in ash content between all the brushes, the volatile component is reduced when the preheating treatment is conducted (see the difference between the present invention brush A2 and the present invention brush A3).

### Second Group of Examples

### Example

First, 70 mass % of artificial graphite powder (average particle size 15 μm) and 30 mass % of pitch as a binder were blended, and further, mesocarbon powder having an indefinite shape (average particle size 20 μm) was added thereto in an amount of 0.9 mass % with respect to the total amount of the artificial graphite powder and the pitch. Next, the artificial graphite powder, the pitch, and the mesocarbon powder were kneaded at 200° C. for a predetermined time (60 minutes) so that they can be uniformly mixed.

Subsequently, the kneaded material was pulverized to an average particle size 80 μm or less, to form a forming powder for forming a brush. This forming powder was formed at a pressure of 1 ton/cm² by cold pressing, and thereafter heat-treated at 650° C. under an inert atmosphere, whereby a carbon brush was fabricated.

The carbon brush fabricated in this manner is hereinafter referred to as a present invention brush B.

### Comparative Example

A carbon brush was fabricated in the same manner as described in Example above, except that bentonite powder was added (the amount thereof was 0.6 mass % with respect to the total amount of the artificial graphite powder and the pitch) in place of the mesocarbon powder having an indefinite shape.

The carbon brush fabricated in this manner is hereinafter referred to as a comparative brush Y.

### Experiment 1

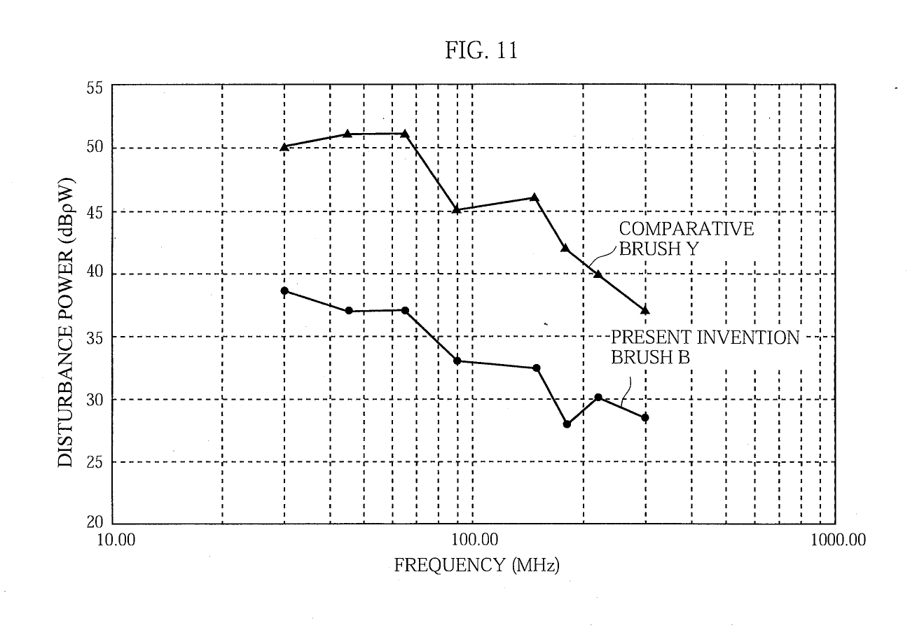

The EMI performance (performance that is considered important for power tool applications) was determined for each of the present invention brush B and the comparative brush Y. The results are shown in FIGS. 10 and 11. The EMI performance was determined by measuring the terminal disturbance voltage and the disturbance power by an EMI test according to CISPR 14 standard.

FIG. 10 clearly shows that there is no difference in terminal disturbance voltage between the present invention brush B and the comparative brush Y in the frequency range up to 15 MHz, but in the range above 15 MHz, the present invention brush B exhibits lower disturbance voltages than the comparative brush Y. Moreover, FIG. 11 clearly shows that when the frequency is 30 MHz or higher, the present invention brush B exhibits remarkably lower disturbance powers than the comparative brush Y.

The EMI performance becomes an issue in a high frequency region (15 MHz or higher, particularly 30 MHz). In that region, the present invention brush B shows lower terminal disturbance voltages and lower disturbance powers than the comparative brush Y, as described above. This demonstrates that the present invention brush B is better in EMI performance than the comparative brush Y.

### Experiment 2

The bulk density, hardness, resistivity, and flexural strength were determined for each of the present invention brush B and he comparative brush Y. The results are shown in Table 3.

TABLE 3

| | Additive | | | | | | Flexural |
|---|---|---|---|---|---|---|---|
| | | | Amount | Bulk density | Hardness | Resistivity | strength |
| Brush | Type | Shape | (mass %) | (Mg/m³) | (Shore type C) | (μΩ · m) | (MPa) |
| B | Mesocarbon | Indefinite | 0.9 | 1.52 | 38 | 1200 | 17 |
| Y | Bentonite | — | 0.6 | 1.53 | 38 | 1390 | 19 |

Table 3 above clearly shows that there is no significant difference in bulk density, hardness, resistivity, and flexural strength between the present invention brush B and the comparative brush Y.

### Third Group of Examples

### Example 1

A carbon brush was fabricated in the same manner as described in Example 3 of the First Group of Examples above, except that the amount of the added mesocarbon powder having a substantially spherical shape and having been subjected to the preheating treatment was set at 2 mass %.

The carbon brush fabricated in this manner is hereinafter referred to as a present invention brush C1.

### Example 2

A carbon brush was fabricated in the same manner as described in Example 3 of the First Group of Examples above, except that the amount of the added mesocarbon powder having a substantially spherical shape and having been subjected to the preheating treatment was set at 3 mass %.

The carbon brush fabricated in this manner is hereinafter referred to as a present invention brush C2.

### Experiment 1

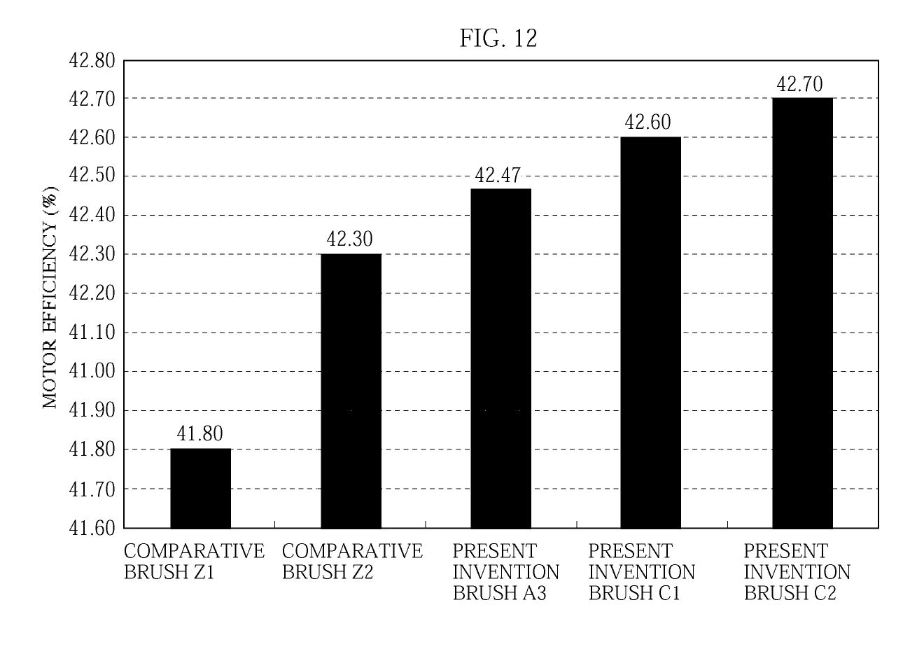

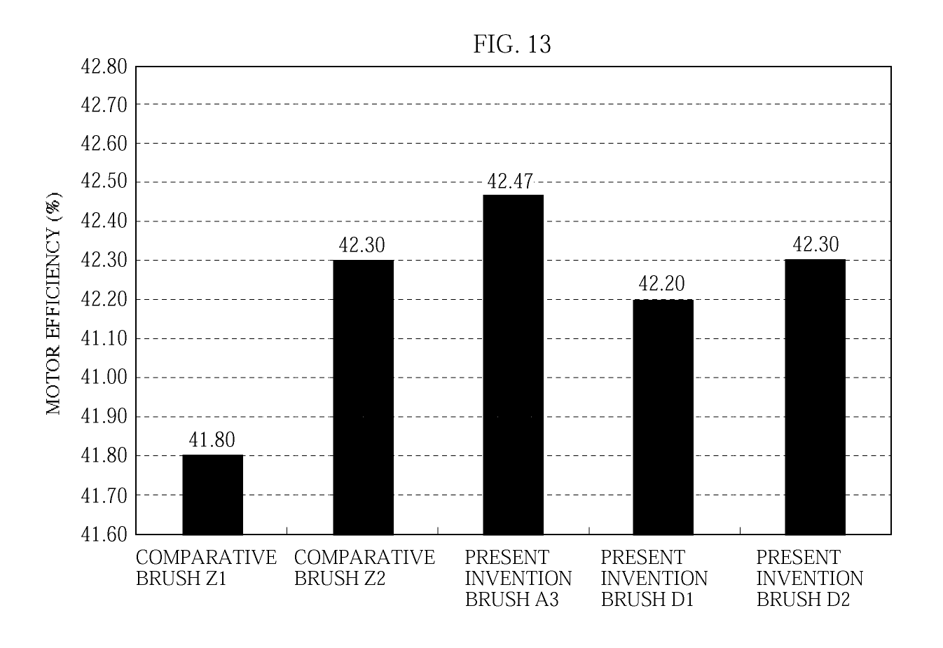

The motor efficiency was determined for each of the present invention brushes C1 and C2. The results are shown in FIG. 12. The method of the experiment was the same as described in Experiment 1 in the First Group of Examples above. FIG. 12 also shows the results of the experiment for the present invention brush A3 as well as the comparative brushes Z1 and Z2.

As is clear from FIG. 12, the present invention brushes C1 and C2, in which the amounts of the added mesocarbon powder were 2 mass % and 3 mass %, respectively, exhibited motor efficiencies of 42.60% and 42.70%, respectively. This means that the resulting motor efficiencies were higher not only than those of the comparative brush Z2 containing no mesocarbon powder (the motor efficiency of which was 42.30%) and the comparative brush Z1 containing SiC powder (the motor efficiency of which was 41.80%) but also than that of the present invention brush A3, in which the amount of the added mesocarbon powder is 1 mass %.

From the foregoing, it is understood that it is preferable that the amount of the added mesocarbon powder is larger, but if the amount of the added mesocarbon powder is too large, the carbon film formed on the commutator surface may be scraped off excessively and good rubbing performance may not be obtained. For this reason, it is desirable that the amount of the mesocarbon powder be 10 mass % or less with respect to the total amount of the binder and the artificial graphite.

### Experiment 2

The bulk density, hardness, resistivity, and flexural strength were determined for each of the present invention brushes C1 and C2. The results are shown in Table 4. Table 4 also shows the results of the experiment for the present invention brush A3 as well as the comparative brushes Z1 and Z2.

TABLE 4

| | Additive | | | | | | | |
|---|---|---|---|---|---|---|---|---|
| | | | | Heat | | | | Flexural |
| | | | Amount | treatment | Bulk density | Hardness | Resistivity | strength |
| Brush | Type | Shape | (mass %) | (° C.) | (Mg/m³) | (Shore type C) | (μΩ · m) | (MPa) |
| A3 | Mesocarbon | Substantially | 1 | Yes | 1.39 | 15 | 1011 | 18 |
| C1 | | spherical | 2 | (600) | 1.40 | 15 | 1040 | 19 |
| C2 | | | 3 | | 1.39 | 15 | 1062 | 19 |
| Z1 | SiC | — | 0.3 | — | 1.40 | 15 | 900 | 18 |
| Z2 | None | — | — | — | 1.40 | 15 | 913 | 18 |

Table 4 above clearly shows that there is no significant difference in bulk density, hardness, resistivity, and flexural strength between the present invention brushes A3, C1, and C2 and the comparative brushes Z1 and Z2.

### Fourth Group of Examples

### Example 1

A carbon brush was fabricated in the same manner as described in Example 3 of the First Group of Examples above, except that the preheating treatment temperature for the mesocarbon powder having a substantially spherical shape was set at 800° C.

The carbon brush fabricated in this manner is hereinafter referred to as a present invention brush D1.

### Example 2

A carbon brush was fabricated in the same manner as described in Example 3 of the First Group of Examples above, except that the preheating treatment temperature for the mesocarbon powder having a substantially spherical shape was set at 1100° C.

The carbon brush fabricated in this manner is hereinafter referred to as a present invention brush D2.

### Experiment 1

The motor efficiency was determined for each of the present invention brushes D1 and D2. The results are shown in FIG. 13. The method of the experiment was the same as described in Experiment 1 in the First Group of Examples above. FIG. 13 also shows the results of the experiment for the present invention brush A3 as well as the comparative brushes Z1 and Z2.

As is clear from FIG. 13, the present invention brushes D1 and D2, in which the preheating treatment temperatures for the mesocarbon powder were 800° C. and 1100° C., respectively, exhibited motor efficiencies of 42.20% and 42.30%, respectively. This means that the resulting motor efficiencies were higher than that of the comparative brush Z1 containing SiC powder (the motor efficiency of which was 41.80%) and were substantially the same as that of the comparative brush Z2 containing no mesocarbon powder (the motor efficiency of which was 42.30%). However, the resulting motor efficiencies were slightly lower than that of the present invention brush A3, in which the preheating treatment temperature for the mesocarbon powder was 600° C.

From the foregoing, it is understood that the motor efficiency deteriorates when the preheating treatment temperature for the mesocarbon powder is excessively high. Therefore, it is preferable that the temperature of the preheating treatment be 700° C. or lower. It should be noted that it is preferable that the temperature of the preheating treatment be 500° C. or higher because, although not shown in FIG. 13, the advantageous effects obtained by the preheating treatment cannot be obtained if the temperature of the preheating treatment is too low.

### Experiment 2

The bulk density, hardness, resistivity, and flexural strength were determined for each of the present invention brushes D1 and D2. The results are shown in Table 5. Table 5 also shows the results of the experiment for the present invention brush A3 as well as the comparative brushes Z1 and Z2.

TABLE 5

| | Additive | | | | | | | |
|---|---|---|---|---|---|---|---|---|
| | | | | Heat | | | | Flexural |
| | | | Amount | treatment | Bulk density | Hardness | Resistivity | strength |
| Brush | Type | Shape | (mass %) | (° C.) | (Mg/m³) | (Shore type C) | (μΩ · m) | (MPa) |
| A3 | Mesocarbon | Substantially | 1 | Yes | 1.39 | 15 | 1011 | 18 |
| | | spherical | | (600) | | | | |
| D1 | | | | Yes | 1.39 | 14 | 993 | 18 |
| | | | | (800) | | | | |
| D2 | | | | Yes | 1.40 | 14 | 1024 | 18 |
| | | | | (1100) | | | | |
| Z1 | SiC | — | 0.3 | — | 1.40 | 15 | 900 | 18 |
| Z2 | None | — | — | — | 1.40 | 15 | 913 | 18 |

Table 5 above clearly shows that there is no significant difference in bulk density, hardness, resistivity, and flexural strength between the present invention brushes A3, D1, and D2 and the comparative brushes Z1 and Z2.

### INDUSTRIAL APPLICABILITY

The carbon brush of the present invention can be used for, for example, electric motors using a commutator, for use in home electrical appliances, power tools, and automobiles.

### REFERENCE SIGNS LIST

1—Brush

2—Rotor

1-7. (canceled)

8. A carbon brush to be pressed against an electrically-conductive rotor, characterized by containing mesocarbon powder and an aggregate material containing carbon as at least one component thereof.

9. The carbon brush according to claim 8, wherein the mesocarbon powder has a substantially spherical shape.

10. The carbon brush according to claim 8, wherein the mesocarbon powder is one having been subjected to a preheating treatment.

11. The carbon brush according to claim 9, wherein the mesocarbon powder is one having been subjected to a preheating treatment.

12. The carbon material according to claim 10, wherein the temperature of the preheating treatment is from 500° C. to 700° C.

13. The carbon material according to claim 11, wherein the temperature of the preheating treatment is from 500° C. to 700° C.

14. The carbon brush according to claim 8, further comprising a binder in addition to the aggregate material and the mesocarbon powder, and wherein the amount of the mesocarbon powder is from 0.1 mass % to 10.0 mass % with respect to the total amount of the binder and the aggregate material.

15. The carbon brush according to claim 9, further comprising a binder in addition to the aggregate material and the mesocarbon powder, and wherein the amount of the mesocarbon powder is from 0.1 mass % to 10.0 mass % with respect to the total amount of the binder and the aggregate material.

16. The carbon brush according to claim 10, further comprising a binder in addition to the aggregate material and the mesocarbon powder, and wherein the amount of the mesocarbon powder is from 0.1 mass % to 10.0 mass % with respect to the total amount of the binder and the aggregate material.

17. The carbon brush according to claim 11, further comprising a binder in addition to the aggregate material and the mesocarbon powder, and wherein the amount of the mesocarbon powder is from 0.1 mass % to 10.0 mass % with respect to the total amount of the binder and the aggregate material.

18. The carbon brush according to claim 12, further comprising a binder in addition to the aggregate material and the mesocarbon powder, and wherein the amount of the mesocarbon powder is from 0.1 mass % to 10.0 mass % with respect to the total amount of the binder and the aggregate material.

19. The carbon brush according to claim 13, further comprising a binder in addition to the aggregate material and the mesocarbon powder, and wherein the amount of the mesocarbon powder is from 0.1 mass % to 10.0 mass % with respect to the total amount of the binder and the aggregate material.

20. The carbon brush according to claim 8, wherein the mesocarbon powder has an average particle size of from 5 μm to 80 μm.

21. The carbon brush according to claim 9, wherein the mesocarbon powder has an average particle size of from 5 μm to 80 μm.

22. The carbon brush according to claim 10, wherein the mesocarbon powder has an average particle size of from 5 μm to 80 μm.

23. The carbon brush according to claim 11, wherein the mesocarbon powder has an average particle size of from 5 μm to 80 μm.

24. The carbon brush according to claim 12, wherein the mesocarbon powder has an average particle size of from 5 μm to 80 μm.

25. The carbon brush according to claim 13, wherein the mesocarbon powder has an average particle size of from 5 μm to 80 μm.

26. The carbon brush according to claim 14, wherein the mesocarbon powder has an average particle size of from 5 μm to 80 μm.

27. A carbon brush, characterized by having a motor efficiency of greater than 42% and a brush life of longer than 800 hours, as determined in a motor efficiency measurement in which the brush is pressed against a motor when the motor has been continuously operated for 700 hours under the following conditions:
a brush spring pressure to the motor of 41 KPa;
an applied voltage of AC 240 V, 50 Hz; and
a motor revolution of 32000 rpm.
